(19) United States
(12) Patent Application Publication
(10) Pub. No.: US 2011/0102586 A1
(43) Pub. Date: May 5, 2011

(54) PTZ CAMERA AND CONTROLLING METHOD OF THE PTZ CAMERA

(75) Inventors: TSE YANG, Tu-Cheng (TW); PI-JYE TSAUR, Tu-Cheng (TW)

(73) Assignee: HON HAI PRECISION INDUSTRY CO., LTD., Tu-Cheng (TW)

(21) Appl. No.: 12/758,803

(22) Filed: Apr. 13, 2010

(30) Foreign Application Priority Data
Nov. 5, 2009 (CN) 200910309360.9

(51) Int. Cl. H04N 7/18

(52) U.S. Cl. 348/143; 348/E07.085

(57) ABSTRACT

A method can control a pan-tilt-zoom (PTZ) camera to monitor an area. The method sets a monitoring path for the PTZ camera, captures a plurality of navigation images of the monitored area at different positions of the monitoring path, and obtains position information of each of the navigation images based upon an image space coordinate system. The method further sets a sequence of the navigation images, and sets a directional control icon for each of the navigation images according to the set sequence and the position information. According to the movement direction pointed by the directional control icon of each of the captured image, the PTZ camera can move along the monitoring path to capture a video stream of the monitored area.

### BACKGROUND

1. Technical Field

Embodiments of the present disclosure relate to cameras and controlling methods for cameras, and more particularly to a pan-tilt-zoom (PTZ) camera and a method for controlling the PTZ camera.

2. Description of Related Art

A pan-tilt-zoom (PTZ) camera is almost always used to monitor area by capturing images of the area with a preset time interval. Because of movement errors of the PTZ camera, the PTZ camera cannot accurately monitor an area in accordance with the preset time interval, thus causing the captured images of the PTZ camera to not be ideal.

What is needed, therefore, is an improved PTZ camera and a method to overcome the limitations described.

### BRIEF DESCRIPTION OF THE DRAWINGS

FIG. 1 is a block diagram of one embodiment of a PTZ camera comprising a management unit.

FIG. 2 is a schematic diagram of one exemplary embodiment of a monitoring path comprising of a plurality of navigation images.

FIG. 3 is a schematic diagram of one embodiment illustrating an example of a position relationship of the navigation images A and B.

FIG. 4 is a schematic diagram of one embodiment illustrating an example of a sequence of the navigation images included in FIG. 2.

FIG. 5 is a schematic diagram illustrating an exemplary table of a movement speed of the PTZ camera from one directional control icon to a next directional control icon.

FIG. 6 is a flowchart illustrating one embodiment of a controlling method for a PTZ camera.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

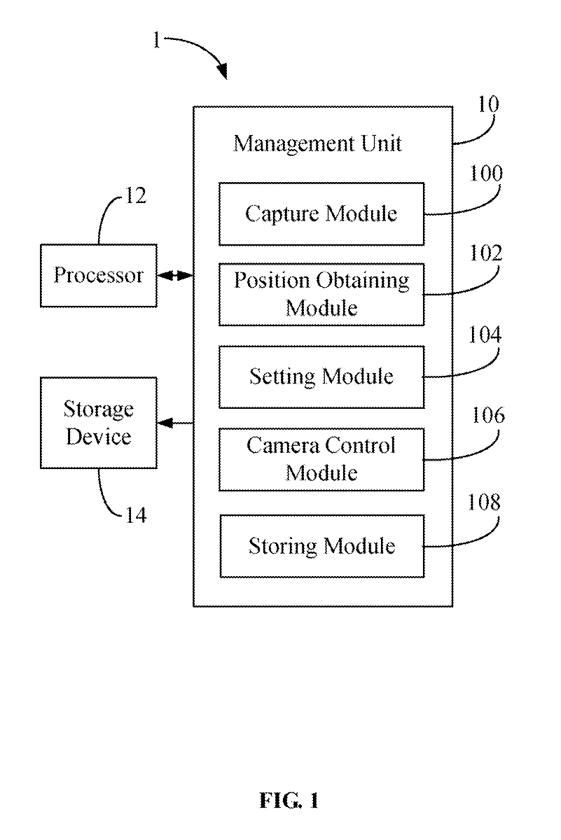

FIG. 1 is a block diagram of one embodiment of a pan-tilt-zoom (PTZ) camera 1 comprising of a management unit 10. In one embodiment, the PTZ camera 1 further includes one or more processors 12, and a storage device 14. The management unit 10 may be used to manage a movement direction and a movement speed of the PTZ camera 1. For example, the management unit 10 controls the PTZ camera 1 to move along a preset monitoring path according to a preset movement speed, so as to capture a video stream of a monitored area. In the embodiment, a viewer can acknowledge a situation of the monitored area by viewing the video stream captured by the PTZ camera 1. The one or more processors 12 is used to execute one or more computerized operations of the managing unit 10 that may be stored in the storage device 14. The storage device 14 may be, for example, a hard disk drive, a compact disc, a digital video disc, or a tape drive.

In one embodiment, the management unit 10 may include a capture module 100, a position obtaining module 102, a setting module 104, a camera control module 106, and a storing module 108. Further details of these modules 100-108 will be explained below.

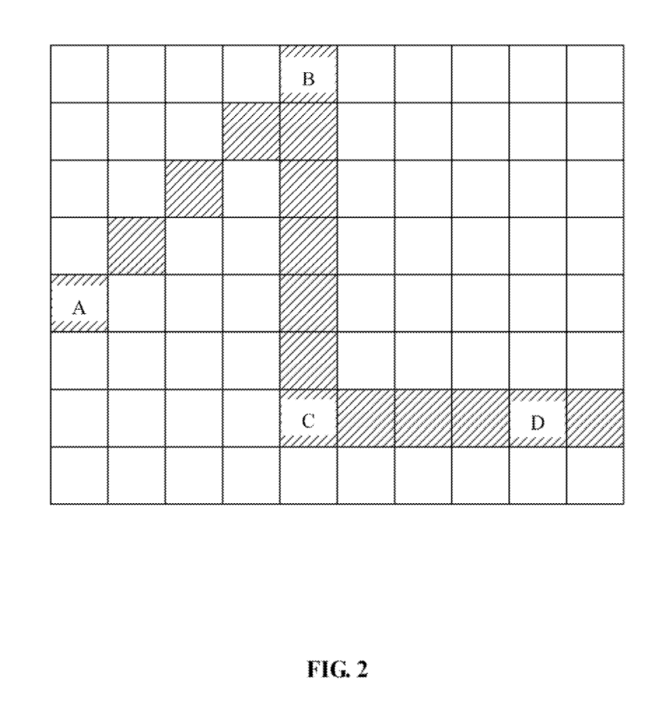

The capture module 100 sets a monitoring path for the PTZ camera 1, and captures a plurality of navigation images of the monitored area at different positions of the monitoring path. In the embodiment, the capture module 100 sets an image space coordinate system, arranges the navigation images in the image space coordinate system, and partitions each of the navigation images into a plurality of squares in a two dimensional plane. As illustrated in FIG. 2, the size of each of the plurality of squares is identical to the size of an image captured by the PTZ camera 1. The capture module 100 sets a monitoring path for the PTZ camera 1 in the two dimensional plane, and captures the navigation images at inflection points of the monitoring path, such as the navigation images “A,” “B,” “C,” and “D.”

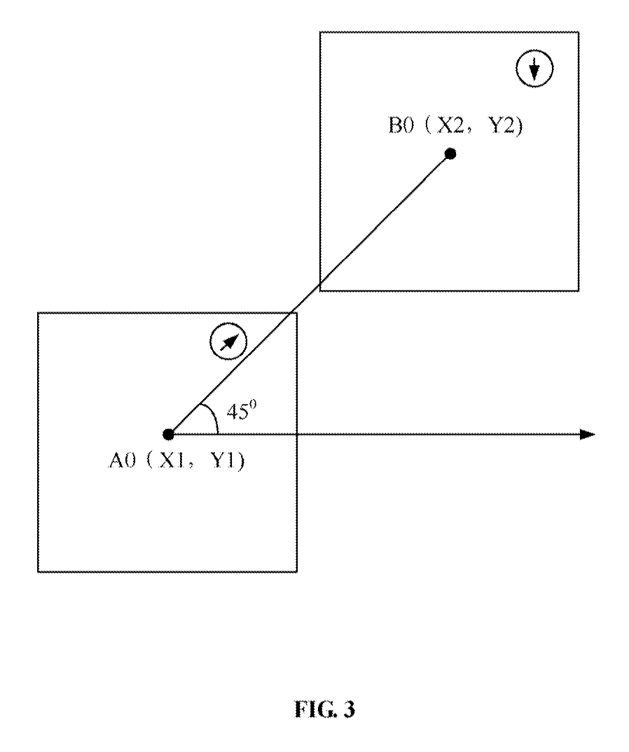

The position obtaining module 102 obtains position information of each of the navigation images based upon the image space coordinate system. In the embodiment, the position information includes a coordinate value of a center point of each of the navigation images in the two dimensional plane of the image space coordinate system. As described in FIG. 3, the position information of the navigation image “A” means the coordinate value (X1 and Y1) of the center point “A0,” and the position information of the navigation image “B” means the coordinate value (X2 and Y2) of the center point “BO.”

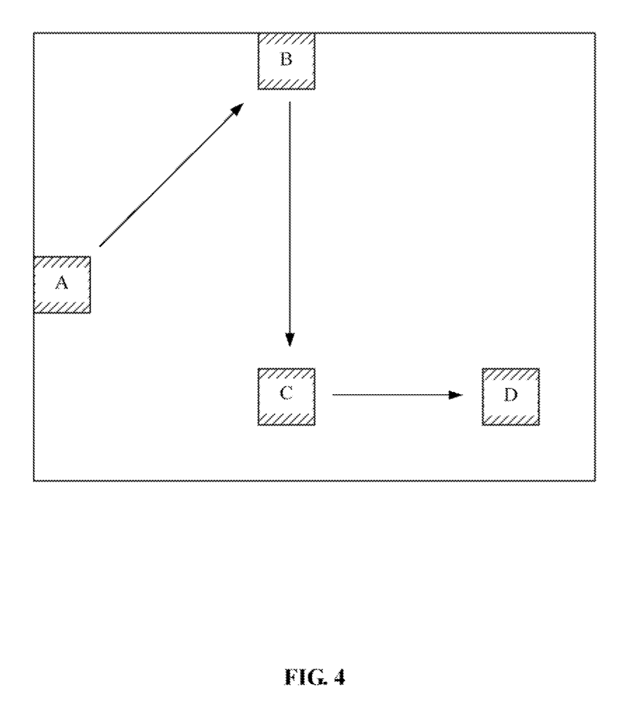

The setting module 104 sets a sequence of the navigation images according to the monitoring path. See in FIG. 4, the sequence of the navigation images of FIG. 2 may be set as the navigation images “A→B→C→D.” According to the set sequence and the position information of each of the navigation images, the setting module 104 sets a directional control icon for each of the navigation images to point to a movement direction of the PTZ camera 1. See in FIG. 3, the setting module 104 computes that the navigation image “B” is at a sloping angle of 45° corresponding to the navigation image “A,” so the setting module 104 sets the direction control icon of the navigation image “A” as “ [symbol] .” Because the navigation image “C” of FIG. 4 is just below the navigation image “B,” and the navigation image “D” is at the right hand of the navigation image “C,” the setting module 104 sets the direction control icon of the navigation image “B” as “↓,” and sets the direction control icon of the navigation image “C” as “→.” The setting module 104 further displays the direction control icon of each of the navigation images on a predetermined position of the corresponding navigation image. For example, the direction control icon of each of the navigation images is indicated on the top-right corner of the navigation image.

The camera control module 106 controls the PTZ camera 1 to move along the monitoring path, and capture a video stream of the monitored area according to the movement direction pointed by the directional control icon of each of the navigation images. In the embodiment, the movement speed of the PTZ camera 1 from one directional control icon to a next directional control icon can be set by the setting module 104.

The storing module 108 stores the monitoring path, the navigation images, the position information of each of the navigation images, the set sequence, and the directional control icon of each of the navigation images in the storage device 14.

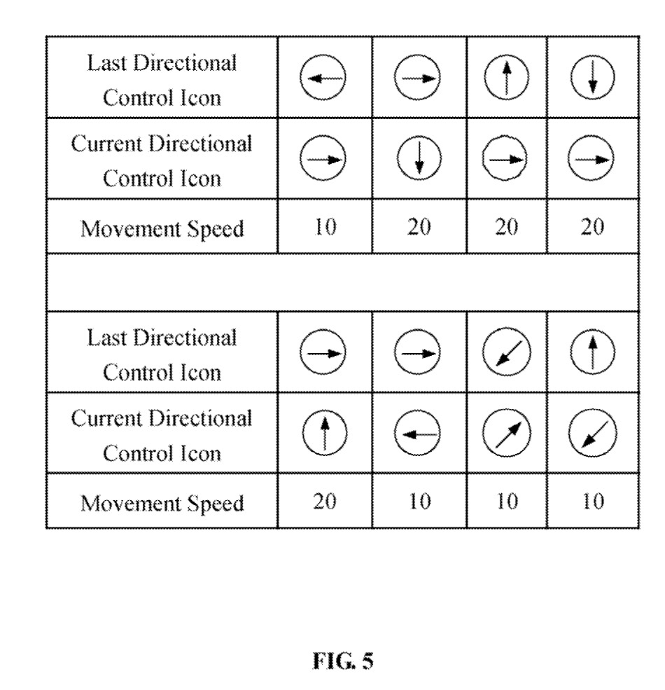

FIG. 5 is a schematic diagram illustrating an exemplary table of the movement speed of the PTZ camera 1 from one directional control icon to a next directional control icon. In FIG. 5, if the last direction control icon is “←,” and a current direction control icon is “→,” the movement speed of the PTZ camera 1 may be set as ten centimeters per second. If the last direction control icon is “→,” and a current direction control icon is “↓,” the movement speed of the PTZ camera 1 may be set as twenty centimeters per second. In the embodiment, the movement speed of the PTZ camera 1 from one type of directional control icon to the other types of directional control icons can be set by an operator.

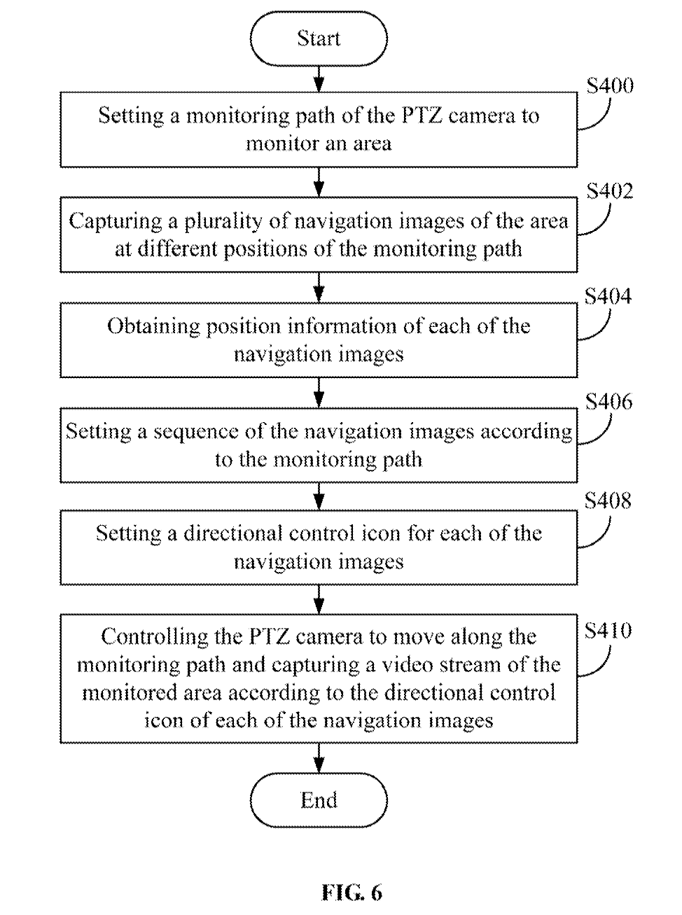

FIG. 6 is a flowchart illustrating one embodiment of a controlling method of the PTZ camera 1.

In block S400, the capture module 100 sets a monitoring path for the PTZ camera 1 monitoring an area. The storing module 108 stores the monitoring path in the storage device 14.

In block S402, the capture module 100 captures a plurality of navigation images of the monitored area at different positions of the monitoring path. For example, the capture module 100 captures the navigation images at inflection points of the monitoring path, such as the navigation images “A,” “B,” “C,” and “D” in FIG. 2 The storing module 108 stores the navigation images in the storage device 14.

In block S404, the position obtaining module 102 obtains position information of each of the navigation images based upon an image space coordinate system. In the embodiment, the capture module 100 sets an image space coordinate system, arranges the navigation images in the image space coordinate system, and partitions each of the navigation images into a plurality of squares in a two dimensional plane. As illustrated in FIG. 2, the size of each of the plurality of squares is identical to the size of an image captured by the PTZ camera 1.

In block S406, the setting module 104 sets a sequence of the navigation images according to the monitoring path. See in FIG. 4, the sequence of the navigation images of FIG. 2 may be set as the navigation images “A→B→C→D.” The storing module 108 stores the position information of each of the navigation images in the storage device 14.

In block S408, the setting module 104 arranges a directional control icon for each of the navigation images according to the set sequence and the position information of each of the navigation images, and displays the direction control icon of each of the navigation images on a predetermined position of the corresponding navigation image. For example, the setting module 104 displays the direction control icon on the top-right corner of the corresponding navigation image, and each directional control icon points to a movement direction of the PTZ camera 1. In the embodiment, the setting module 104 further sets a movement speed of the PTZ camera 1 from one directional control icon to another directional control icon.

In block S410, the camera control module 106 controls the PTZ camera 1 to move along the monitoring path, so as to capture a video stream of the monitored area according to the movement direction pointed by the directional control icon of each of the navigation images. Therefore, a viewer can acknowledge a situation of the monitored area by viewing the video stream captured by the PTZ camera 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for controlling a pan-tilt-zoom (PTZ) camera, the method comprising:
(a) setting a monitoring path for the PTZ camera, and capturing a plurality of navigation images of a monitored area at different positions of the monitoring path;
(b) obtaining position information of each of the navigation images based upon an image space coordinate system;
(c) arranging a sequence of the navigation images according to the monitoring path;
(d) setting a directional control icon for each of the navigation images according to the set sequence and the position information of each of the navigation images, the directional control icon pointing to a movement direction of the PTZ camera; and
(e) controlling the PTZ camera to move along the monitoring path and capture a video stream of the monitored area according to the movement direction pointed by the directional control icon of each of the navigation images.

2. The method as described in claim 1, wherein the block (d) further comprises:
setting a movement speed of the PTZ camera from one directional control icon to a next directional control icon.

3. The method as described in claim 2, wherein the block (e) further comprises:
controlling the PTZ camera to move along the monitoring path according to the movement speed.

4. The method as described in claim 1, wherein the position information comprise a coordinate value of a center point of each of the navigation images in the image space coordinate system.

5. A pan-tilt-zoom (PTZ) camera, comprising:
at least one processor;
a storage device; and
a management unit stored in the storage device and executed by the at least one processor, the management unit comprising:
a capture module operable to set a monitoring path for the PTZ camera, and capture a plurality of navigation images of a monitored area at different positions of the monitoring path;
a position obtaining module operable to obtain position information of each of the navigation images based upon an image space coordinate system;
a setting module operable to set a sequence of the navigation images according to the monitoring path, and set a directional control icon for each of the navigation images according to the set sequence and the position information of each of the navigation images, the directional control icon pointing to a movement direction of the PTZ camera; and
a camera control module operable to control the PTZ camera to move along the monitoring path and capture a video stream of the monitored area according to the movement direction pointed by the directional control icon of each of the navigation images.

6. The PTZ camera as described in claim 5, wherein the management unit further comprises a storing module operable to store the monitoring path, the navigation images, the position information of each of the navigation images, the set sequence, and the directional control icon of each of the navigation images in the storage device.

7. The PTZ camera as described in claim 5, wherein the setting module is further operable to set a movement speed of the PTZ camera from one directional control icon to a next directional control icon.

8. The PTZ camera as described in claim 7, wherein the camera control module is further operable to control the PTZ camera to move along the monitoring path according to the movement speed.

9. The PTZ camera as described in claim 5, wherein the position information comprise a coordinate value of a center point of each of the navigation images in the image space coordinate system.

10. A storage medium having stored thereon instructions that, when executed by a processor of a pan-tilt-zoom (PTZ) camera, cause the processor to implement a method for controlling the PTZ camera, the method comprising:
(a) setting a monitoring path for the PTZ camera, and capturing a plurality of navigation images of a monitored area at different positions of the monitoring path;
(b) obtaining position information of each of the navigation images based upon an image space coordinate system;
(c) arranging a sequence of the navigation images according to the monitoring path;
(d) setting a directional control icon for each of the navigation images according to the set sequence and the position information of each of the navigation images, the directional control icon pointing to a movement direction of the PTZ camera; and
(e) controlling the PTZ camera to move along the monitoring path, and capturing a video stream of the monitored area according to the movement direction pointed by the directional control icon of each of the navigation images.

11. The storage medium as described in claim 10, wherein the block (d) further comprises:
setting a movement speed of the PTZ camera from one directional control icon to a next directional control icon.

12. The storage medium as described in claim 11, wherein the block (e) further comprises:
controlling the PTZ camera to move along the monitoring path according to the movement speed.

13. The storage medium as described in claim 10, wherein the position information comprise a coordinate value of a center point of each of the navigation images in the image space coordinate system.
